(19) United States
(12) Patent Application Publication
(10) Pub. No.: US 2023/0347612 A1
(43) Pub. Date: Nov. 2, 2023

(54) METHOD OF MANUFACTURING A SPAR CAP FOR A WIND TURBINE BLADE PART

(71) Applicants: LM WIND POWER A/S, Kolding (DK); BLADE DYNAMICS LLLP, New Orleans, LA (US)

(72) Inventors: Kristen HANRAHAN, New Orleans, LA (US); Justin HUNTER, New Orleans, LA (US); Christopher BOON, Eastleigh Hampshire (GB); Tanner KNOBLOCK, New Orleans, LA (US); Jasper KNOBLOCK, New Orleans, LA (US)

(21) Appl. No.: 17/921,337

(22) PCT Filed: May 25, 2020
(86) PCT No.: PCT/EP2020/064412

§ 371 Date: Oct. 25, 2022

(51) Int. Cl. B29D 99/00; B29C 70/06; B29C 70/48; B29C 33/58; B29C 70/44; B29C 70/86

(52) U.S. Cl. CPC B29D 99/0028; B29C 70/06; B29C 70/48; B29C 33/58; B29C 70/443; B29C 70/86; B29K 2307/04

(57) ABSTRACT

A method of manufacturing a spar cap for a wind turbine blade part, comprise the steps of:
providing a plurality of precured elongated fibre reinforced resin elements
stacking the plurality of fibre reinforced elements, an interlayer of an elongated non-cured fibre material being arranged between successive fibre reinforced elements, thereby forming a stack of precured fibre reinforced elements,
moving the stack of fibre reinforced elements to a spar cap mould comprising a mould bottom and mould side walls,
arranging the stack of fibre reinforced elements in the cavity of the spar cap mould
infusing resin into the stack of fibre reinforced elements in the mould
allow the resin to cure and demould the stack

### FIELD OF THE INVENTION

The present invention relates to manufacturing of spar cap for a wind turbine blade.

### BACKGROUND OF THE INVENTION

Wind power is a clean and environmentally friendly source of energy. Wind turbines usually comprise a tower, generator, gearbox, nacelle, and one or more rotor blades. The wind turbine blades capture kinetic energy of wind using known airfoil principles. Modern wind turbines may have rotor blades that exceed 90 meters in length.

Wind turbine blades are usually manufactured by forming two shell parts or shell halves from layers of woven fabric or fibre and resin. Spar caps or main laminates are placed or integrated in the shell halves and may be combined with shear webs or spar beams to form structural support. Spar caps or main laminates may be joined to, or integrated within, the inside of the halves of the shell.

A number of manufacturing steps become more complicated as the blades increase in size. Any mistake made somewhere in the process is increasingly more time consuming to correct. One such process step is precise laying of fibres layers and precured elements on fibre layers already laid up in a blade part mould. Additionally, it is a problem to provide the spar cap with the desired dimensions and tolerances especially of the width and thickness. The width thickness and length of the spar cap usually increase with the size of the blade.

When manufacturing a wind turbine blade shell part, layers of dry fibre, such as fibre mats, are typically laid up first in a blade shell part mould. These layers will constitute the outer skin of the shell part. After adding the fibre layers, additional layers forming part of the spar cap, one or more precured elements can be added, forming a further part of the spar cap blade shell part. Spar caps are advantageously provided using this method. Adding the additional layers and the precured elements onto the outer skin fibre layers is tedious, and often the fibre layers get displaced or wrinkled or misplaced, thereby reducing the dimensional tolerances and the quality of the spar and the wind turbine blade shell and thereby probably also the complete blade shell.

It is therefore desirable to provide a method of manufacturing eliminating or reducing the drawbacks of known methods and provide an effective and reliable method of manufacturing spar caps of the desired dimensions and tolerances.

The present invention provides a method of manufacturing eliminating or reducing the drawbacks of known methods.

### SUMMARY OF THE INVENTION

The present invention provides a method of manufacturing a spar cap for a wind turbine blade part, comprising the steps of:
providing a plurality of precured elongate elements of a fibre reinforced resin composite material comprising a first main surface and a second opposite main surface and a first lateral face and a second opposite lateral face and a first end and an opposite second end
stacking the plurality of precured elements, an interlayer of an elongate non-cured fibre material being arranged between the first and second main surface of successive precured elements, thereby forming a stack of precured elements and interlayer(s), the stack having a lower stack surface and an opposite upper stack surface, a first lateral stack face and an opposite second lateral stack face, and a first stack end and an opposite second stack end
moving the stack of precured elements and interlayer(s) to a spar cap mould comprising a mould bottom and mould side walls,
arranging the stack of precured elements and interlayer(s) in the cavity of the spar cap mould
infusing resin into the stack of precured elements and interlayers in the mould
allow the resin to cure to form a cured stack of precured elements and interlayer(s) forming a spar cap
remove the cured stack of precured elements and interlayer(s) in from the mould, i.e. demould the stack

The present invention provides for a spar cap having dimensions with close tolerances as the spar cap is moulded in a spar cap mould maintaining the cured elements and the interlayer(s) in the desired position and preventing displacement thereof.

The plurality of precured elements can be stacked in a single row or in two or more rows of precured elements arranged laterally adjacent each other

According to an embodiment the precured elements comprise carbon fibres and/or glass fibres

According to a further embodiment the resin of resin composite material of the precured elements is epoxy resin, vinyl ester resin or polyester resin

According to an additional embodiment the resin infused into the stack of precured elements and interlayer(s) is of the same type as the resin of the precured elements.

The resin infused into the stack of precured elements and interlayer(s) can also be of a type different from the resin of the precured elements.

According to an at present preferred embodiment the precured elements are plank-shaped or strip-shaped

According to an additional at present preferred embodiment the plurality of precured elements are pultruded elements.

The fibres of the fibres material of the interlayer(s) can comprise glass fibres and/or carbon fibres.

In an embodiment the step of stacking of the precured elements to form a stack of precured elements and interlayer(s) comprises:
aligning at least the lateral faces of the precured elements and keep them aligned by means of longitudinally mutually spaced loose stack clamping devices, preferably surrounding the stack of precured elements and interlayer(s).

Thereby it is advantageously obtained that the cured elements and the interlayer(s) are arranged precisely aligned when arranged in the mould and the dimensional tolerances improved

According to an embodiment the step of moving the stack of precured elements and interlayer(s) to a spar cap mould comprises:
connecting a lifting device such as a lifting beam to the loose stack clamping devices and move the stack of precured elements and interlayer(s) to the mould by means of the lifting device.

According to a further embodiment the step of arranging the stack of precured elements and Interlayer(s) in the cavity of the spar cap mould comprises:
arranging the stack above the mould cavity of the spar cap mould, and
gradually bringing the lower stack surface of the stack into contact with the surface of the mould bottom of the mould cavity, preferably starting at the first stack end and ending at the opposite second stack end, and simultaneously gradually removing the mutually spaced loose stack clamping devices from the stack before contacting the bottom of the mould, preferably starting from the loose stack clamping device closest to the first stack end and ending at the loose stack clamping device closest to the opposite second stack end.

According to an additional embodiment the step of arranging the stack of precured elements and interlayer(s) in the cavity of the spar cap mould comprises:
arranging the stack above and preferably vertically in line with the mould cavity of the spar cap mould on a plurality of longitudinally mutually spaced support members, each support member supporting a stack portion, and removing the clamping devices from the stack, and
gradually bringing the lower stack surface of the stack into contact with the surface of the mould bottom of the mould cavity, preferably starting at the first stack end and ending at the opposite second stack end, by simultaneously gradually removing the support members, preferably starting from the support member closest to the first stack end and ending at the support member closest to the opposite second stack end.

Thereby the stack can be gently and precisely lowered down onto the surface of the bottom.

All the clamping devices can be removed from the stack after the stack has been arranged on the support members. Alternatively, the clamping devices can be removed gradually from the stack simultaneously with the removal of the support members or gradually prior to the gradual removal of the support members.

According to an embodiment the support members extend transversely of the elongate spar cap mould and are supported by upper faces of side walls of the mould.

The support members can be cylindrical members.

According to an advantageous embodiment of the method of the present invention comprises coating the surfaces of the mould bottom and the side walls of the mould cavity by a slip coating, such as a peel ply, prior to arranging the stack of precured elements and interlayer(s) in the cavity of the spar cap mould.

According to a further advantageous embodiment the step of infusing resin into the stack of precured elements and interlayer(s) in the mould comprises: coating the upper surface of the stack of precured elements and interlayers with a peel coating, such as peel ply, and cover the cavity of the spar cap mould with a vacuum bag and infuse the resin by vacuum assisted resin transfer moulding (VARTM).

An embodiment of the present invention of the can comprise carrying out an inspection of the cured stack of precured elements and interlayer(s) after the cured stack has been removed from the spar cap mould, conduct any required repairs of the cured stack and send the stack to shell part mould or a storage.

The cured stack of elements and interlayer(s), i.e. the cap, can have a width in the range 30-800 mm, a thickness or height in the range of 10-200 mm and a length in the range 10-200 m

At the shell part mould the cured stack of cured elements and interlayer(s), i.e the spar cap, is placed on the desired place of one or more fibres layers arranged in the shell part mould and additional shell materials and consumables are added, where after the shell part is infused, such as by VARTM.

A second aspect of the present invention relates to a wind turbine blade being provided with a spar cap manufactured by the method according to the present invention.

A third aspect of the present invention related to a wind turbine rotor being provided with at least one blade being provided with a spar cap manufactured by a method according to the present invention.

A fourth aspect of the present invention relates to a wind turbine comprising a wind turbine rotor being provided with at least one blade being provided with a spar cap manufactured by a method according to the present invention.

### BRIEF DESCRIPTION OF THE FIGURES

Embodiments of the invention will be described in more detail in the following with regard to the accompanying figures. The figures show one way of implementing the present invention and are not to be construed as being limiting to other possible embodiments falling within the scope of the attached claim set.

FIG. 1 is a schematic view illustrating an exemplary wind turbine.

FIG. 2 is a schematic view illustrating an exemplary wind turbine blade.

FIG. 3 is a schematic view illustrating a cross-section of an exemplary wind turbine blade.

FIG. 4 is a schematic view of a loose stack of precured elongate elements of fibre reinforced resin composite material and interlayers of fibre material.

FIG. 5A is a schematic view illustrating in reduced scale a loose stack clamping device attached to the stack shown in FIG. 4.

FIG. 5B is a schematic view illustrating a lifting device in the form of a lifting beam connected to the loose stack clamping device shown in FIG. 5A.

FIGS. 6A-6F is schematic views illustrating arranging the loose stack in a spar cap mould illustrate a method in accordance with an embodiment of the invention, for arranging precured elements on fibre layers arranged in a shell part mould.

FIG. 7 is a schematic view illustrating moulding of the loose stack in the spar cap mould for forming the spar cap.

FIG. 8 is a schematic view illustrating the moulded and cured spar cap removed from the spar cap mould.

FIG. 9 is a schematic view illustrating the finished cured spar cap after removal of peel ply

### DETAILED DESCRIPTION OF THE INVENTION

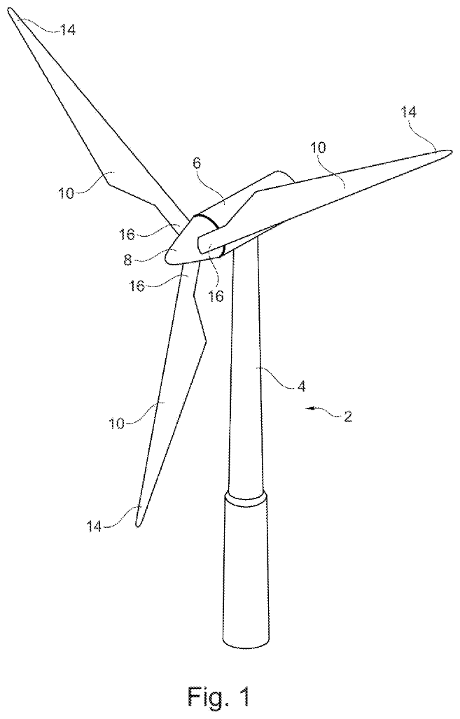

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each blade having a blade root 16 nearest the hub and a blade tip 14 furthest from the hub 8. The invention is not limited to use in wind turbines of this type.

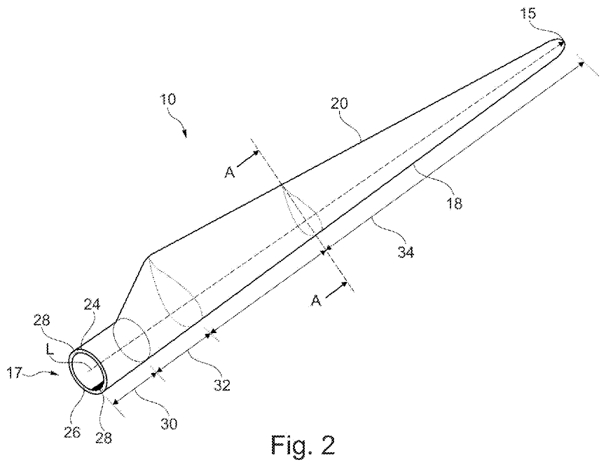

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or airfoil region 34, and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) preferably has an ideal shape with respect to generating hub rotation, whereas the root region 30 due to structural considerations has a substantially circular or elliptical cross-section, which for instance makes it easier and safer to mount the blade 10 to the hub. The diameter of the root region 30 may be constant along the entire root area 30. The transition region 32 present in the wind turbine blade 10 in this example has a transitional profile gradually changing from the circular shape of the root region 30 to the airfoil profile of the airfoil region 34. The chord length of the transition region 32 typically increases in an outward direction from the hub. The airfoil region 34 has an airfoil profile with a chord extending between the leading edge 18 and the trailing edge 20 of the blade 10.

It should be noted that different sections of the blade normally do not have a common plane, since the blade may be twisted and/or curved (i.e. pre-bent) along a direction from the root region to the tip, this being most often the case, for instance to more or less compensate for the local velocity of the blade being dependent on the distance from the hub.

The wind turbine blade 10 comprises a blade shell which may for instance comprise two blade shell parts, a first blade shell part 24 and a second blade shell part 26, for instance made at least partly of fibre-reinforced polymer. The first blade shell part 24 may for instance be part of a pressure side or upwind blade part. The second blade shell part 26 may for instance be part of a suction side or downwind blade part. The first blade shell part 24 and the second blade shell part 26 are typically joined together, such as glued together, along bond lines or glue joints 28 extending along the trailing edge 20 and the leading edge 18 of the blade 10. Typically, the root ends of the blade shell parts 24, 26 have a semi-circular or semi-oval outer cross-sectional shape that, when the first and second shell parts are joined, forms the root region, such as a circular or oval root region.

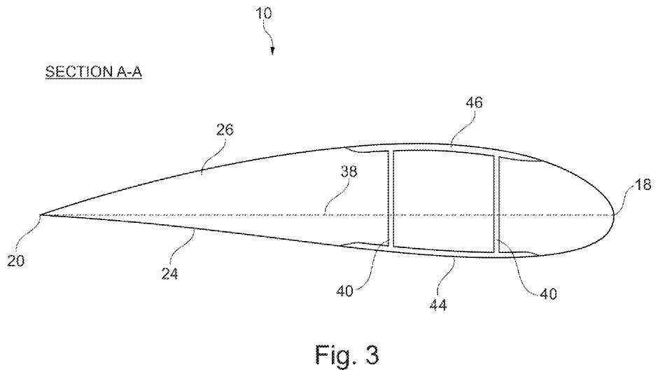

FIG. 3 is a schematic diagram illustrating a cross-sectional view of the exemplary wind turbine blade 10, corresponding to line A-A in FIG. 2. The wind turbine blade 10 comprises shear webs 40, a first spar cap 44 that is part of the pressure side 24 of the blade 10, and a second spar cap 46 that is part of the suction side 26 of the blade 10. The spar caps provide structural strength to the blade and typically extend along the blade in a spanwise direction. Typically, spar caps will extend over 60-95% of the blade length. The trailing edge 20 and leading edge 18 are also indicated in FIG. 3.

FIG. 4 illustrates a first step of the method according to the present invention for manufacturing a spar cap , such as the spar caps 44 and 46 in FIG. 3 and where a plurality of precured elongate elements 50 of a fibre reinforced resin composite material are provided, preferably pultruded elements comprising carbon fibre. The precured elements 50 comprise a first main surface 51 and an opposite second main surface 52 and a first lateral face 53 and an opposite second lateral face 54 and a first end 55 and an opposite second end 56, not shown in FIG. 4. The precured elements 50 are stacked with an interlayer 57 of a non-cured fibre material between the first and second main surface 51,52 of successive precured elements 50, thereby forming a loose stack 58 of precured elements 50 and interlayers 57. The interlayers comprise carbon and/or glass fibres. In the embodiment shown the loose stack 58 comprises an array of two lateral adjacent rows, each comprising four elongate precured elements 50 separated by three interlayers 57. The loose stack 58 has an upper stack surface 59, an opposite lower stack surface 60, a first lateral stack face 61 and an opposite second lateral stack face 62 and a first stack end 63 and an opposite second stack end 64. The first and second stack end are not shown in FIG. 4.

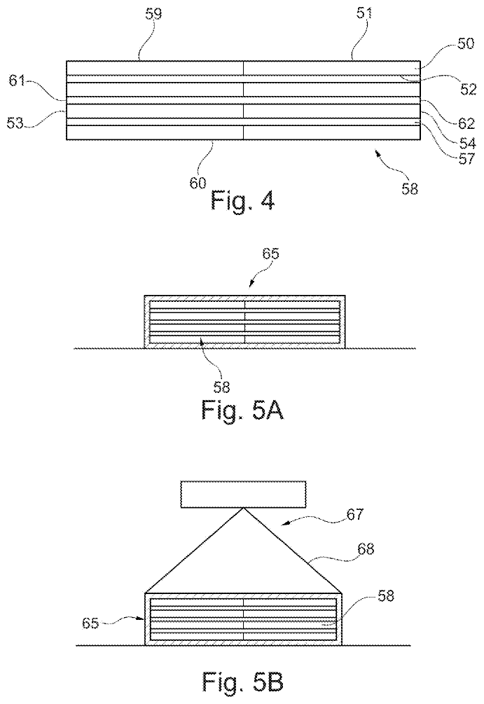

During stacking the precured elements 50 and interlayers 57 or after said stacking at least the lateral side walls 53,54 of the precured elements 50 are aligned and they are kept aligned by means of longitudinally spaced loose stack clamping devices 65. A loose stack clamping device 65 surrounding a loose stack 58 is illustrated in FIG. 5A.

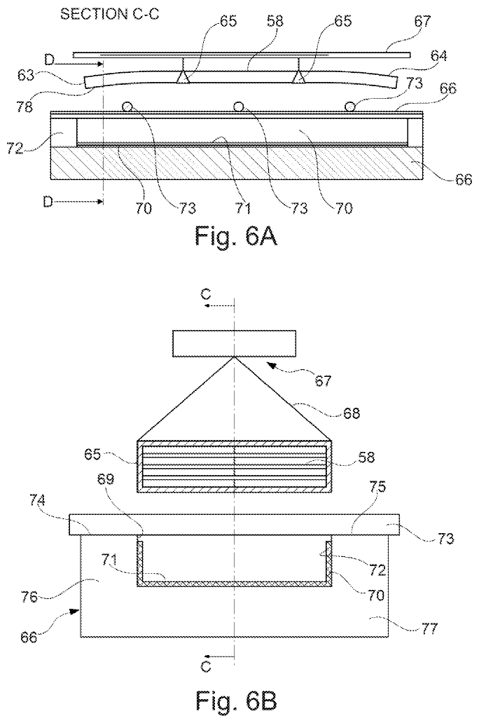

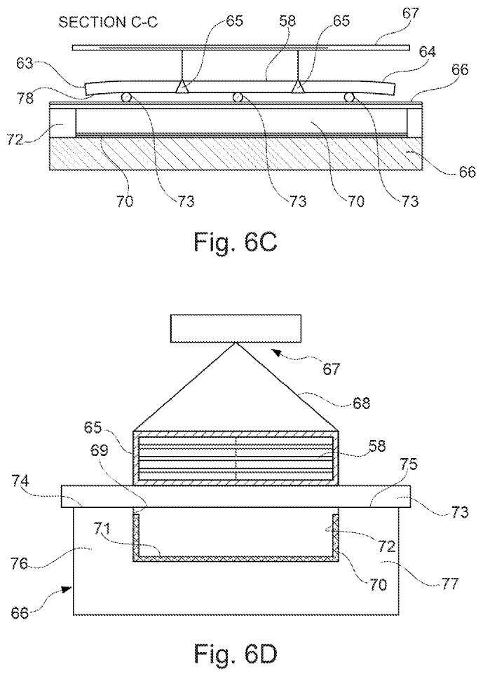

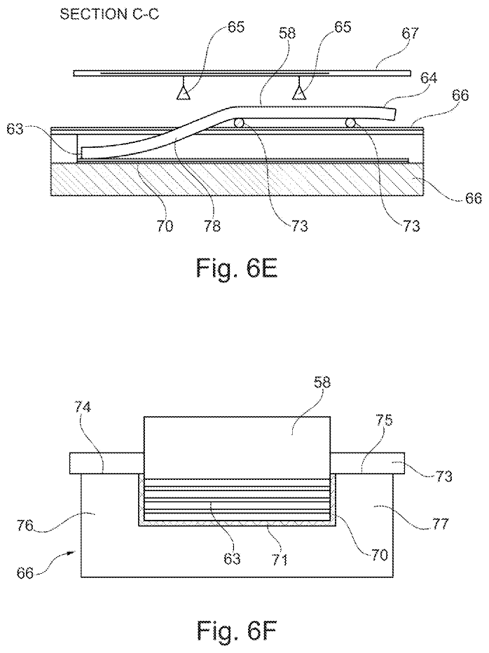

In the next step of the method of the present invention the loose stack 58 surrounded by the mutually spaced loose stack clamping devices 65 is moved to a spar cap mould 66 by connecting a lifting device, in the embodiment shown a lifting beam 67 with lifting ropes, to the loose stack clamping devices 65, as shown in FIG. 5B. The loose stack 58 is moved to the spar cap mould and arranged above the mould essentially vertically in line with the mould 66, as shown in FIG. 6A. FIG. 6A is a cross sectional view in reduced scale along the line C-C in FIG. 6B. FIG. 6B is a view in enlarged scale along the line D-D in FIG. 6A.

The loose stack of precured elements 50 and interlayers 57 can now be brought into the cavity 69 of the mould. However, before that is done a peel ply 70 is applied on the bottom surface 71 and the side wall surfaces 72 of cavity 69 of the mould 66, as shown in FIGS. 6A and 6B.

The loose stack 58 can be arranged in the cavity 69 of the mould by gradually bringing the lower stack surface 78 into contact with the bottom surface 71 of the mould 66 by gradually lowering the loose stack clamping devices 65 starting at the first stack end 63 and ending at the opposite second stack end 64 and simultaneously gradually removing the loose stack clamping devices starting at the clamping device closest to the first end 63 of the loose stack 58 and ending at the clamping device closest to the second end 54 of the loose stack 58.

Alternatively, the loose stack can be arranged in the cavity 69 of the mould 66 by arranging a plurality of transversely extending and longitudinally mutually spaced support members in the form of cylindrical rollers 73 on the upper surfaces 74,75 of the side walls 76,77 of the mould 66. Thereafter the loose stack 58 can be lowered downwards to be supported by the plurality of longitudinally spaced rollers 73, as shown in FIG. 6C and FIG. 6D. Each roller 73 supports a portion of the loose stack 58. The loose stack clamping devices 65 can now be removed from the loose stack. The lower surface 78 of the loose stack 58 is gradually brought into contact with the surface 71 of the mould bottom of the mould cavity 69, starting at the first stack end 63 and ending at the opposite second stack end 64, by simultaneously gradually removing or displacing the rollers 73 starting from the roller closest to the first stack end 63 and ending at the support member closest to the opposite second stack end 64, as shown in FIG. 6E and FIG. 6F. FIG. 6E and FIG. 6F disclose the situation where rollers 73 at the forward end of the loose stack 58 has been removed and the forward end of the loose stack has contacted the surface 71 of the bottom of the cavity 69 of the spar cap mould 66.

All the clamping devices 65 can be removed from the stack 58 after the stack has been arranged on the rollers 73. Alternatively, the clamping devices 65 can be removed gradually from the stack 58 simultaneously with the removal of the rollers 73 or gradually prior to the gradual removal of the rollers 73.

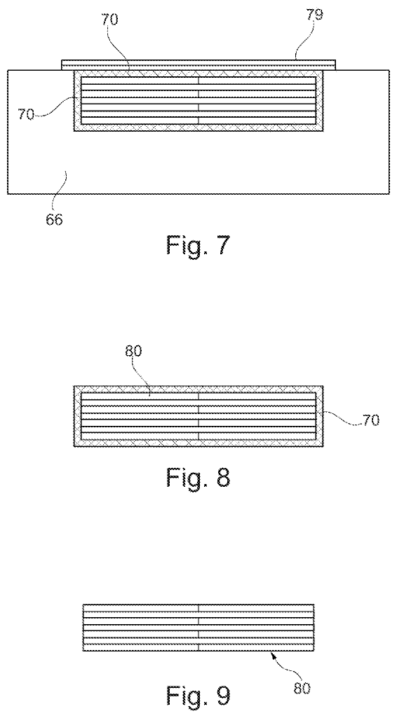

As shown in FIG. 7 a peel ply 70 is arranged on the upper stack surface 59 when the entire length of the lose stack 58 has been arranged in the cavity 69 of the mould 66. Thereafter, the cavity is covered with a vacuum bag 79, vacuum is provided in the mould cavity and resin supplied to the mould cavity, i.e. resin is infused by vacuum assisted resin transfer moulding (VARTM). Subsequently the resin is allowed to cure, thereby forming the spar cap 80, and the cured stack of precured elements and interlayers is removed from the mould as a spar cap 80 surrounded by peel ply 70, as shown in FIG. 8.

Next the spar cap 80 can be inspected and required repair conducted and the spar cap 80 send to a shell part mould or a storage. Preferably the peel ply 70 is not removed from the spar cap 80 until the spar cap is to be used at the shell part mould. At the shell part mould the spar cap is placed on the desired place of one or more fibre layers arranged in the shell part mould and additional shell materials and consumables are added, where after the shell part is infused, such as by VARTM.

### LIST OF REFERENCES

2 wind turbine
4 tower
6 nacelle
8 hub
10 blade
14 blade tip
15 tip end
16 blade root
17 root end
18 leading edge
20 trailing edge
24 first blade shell part (pressure side)
26 second blade shell part (suction side)
28 bond lines/glue joints
30 root region
32 transition region
34 airfoil region
40 shear web
44 first spar cap
46 second spar cap
50 precured element
51 first main surface
52 second main face
53 first lateral face
54 second lateral surface
55 first end
56 second end
57 interlayer
58 loose stack
59 upper stack face
60 lower stack face
61 first lateral stack face
62 second lateral stack face
63 first stack end
64 second stack end
65 loose stack clamping device
66 spar cap mould
67 lifting beam
68 lifting ropes
69 cavity
70 peel ply
71 bottom surface
72 side wall surface
73 roller
74,75 upper surface
76,77 side wall
78 lower stack surface
79 vacuum bag
80 cured stack, spar cap

1-15. (canceled)

16. Method of manufacturing a spar cap for a wind turbine blade part, comprising the steps of:
providing a plurality of precured elongate elements of a fibre reinforced resin composite material comprising a first main surface and a second opposite main surface and a first lateral face and a second opposite lateral face and a first end and an opposite second end,
stacking the plurality of precured elements, an interlayer of an elongate non-cured fibre material being arranged between the first and second main surface of successive precured elements, thereby forming a stack of precured elements and interlayer(s), the stack having a lower stack surface and an opposite upper stack surface, a first lateral stack face and an opposite second lateral stack face, and a first stack end and an opposite second stack end,
moving the stack of precured elements and interlayer(s) to a spar cap mould comprising a mould bottom and mould side walls,
arranging the stack of precured elements and interlayer(s) in the cavity of the spar cap mould
infusing resin into the stack of precured elements and interlayers in the mould,
allow the resin to cure to form a cured stack of precured elements and interlayer(s) forming a spar cap,
remove the cured stack of precured elements and interlayer(s) in from the mould, i.e. demould the stack.

17. Method according to claim 16, wherein the precured elements comprise carbon fibres and/or glass fibres.

18. Method according to claim 16, wherein the resin of the resin composite material of the precured elements is epoxy resin, vinyl ester resin or polyester resin.

19. Method according to claim 16, wherein the resin infused into the stack of precured elements and interlayer(s) is of the same type as the resin of the precured elements.

20. Method according to claim 16 wherein the precured elements are plank-shaped or strip-shaped.

21. Method according to claim 16, wherein the plurality of precured elements are pultruded elements, and/or wherein the fibres of the fibres material of the interlayer(s) comprises glass fibres and/or carbon fibres.

22. Method of claim 16, wherein the step of stacking of the precured elements to form a stack of precured elements and interlayer(s) comprises:
aligning at least the lateral faces of the precured elements and keep them aligned by means of longitudinally mutually spaced loose stack clamping devices, preferably surrounding the stack of precured elements and interlayer(s).

23. Method of claim 16, wherein the step of moving the stack of precured elements and interlayer(s) to a spar cap mould comprises:
connecting a lifting device such as a lifting beam to the loose stack clamping devices and move the stack of precured elements and interlayer(s) to the mould by means of the lifting device.

24. Method of claim 16, wherein the step of arranging the stack of precured elements and interlayer(s) in the cavity of the spar cap mould comprises:
arranging the stack above the mould cavity of the spar cap mould, and
gradually bringing the lower stack surface of the stack into contact with the surface of the mould bottom of the mould cavity, preferably starting at the first stack end and ending at the opposite second stack end, and simultaneously gradually removing the mutually spaced loose stack clamping devices from the stack before contacting the bottom of the mould, preferably starting from the loose stack clamping device closest to the first stack end and ending at the loose stack clamping device closest to the opposite second stack end.

25. Method of claim 16, wherein arranging the stack of precured elements and interlayer(s) in the cavity of the spar cap mould comprises:
arranging the stack above the mould cavity of the spar cap mould on a plurality of longitudinally mutually spaced support members, each support member supporting a stack portion, and removing the clamping devices from the stack, and
gradually bringing the lower stack surface of the stack into contact with the surface of the mould bottom of the mould cavity, preferably starting at the first stack end and ending at the opposite second stack end, by simultaneously gradually removing the support members, preferably starting from the support member closest to the first stack end and ending at the support member closest to the opposite second stack end.

26. Method according to claim 25, wherein the support members extend transversely of the elongate spar cap mould and are supported by upper faces of side walls of the mould.

27. Method according to claim 16, comprising coating the surfaces of the mould bottom and the side walls of the mould cavity by a slip coating, such as a peel ply, prior to arranging the stack of precured elements and interlayer(s) in the cavity of the spar cap mould.

28. Method according to claim 16, wherein the step of infusing resin into the stack of precured elements and interlayer(s) in the mould comprises: coating the upper surface of the stack of precured elements and interlayers with a peel coating, such as peel ply, and cover the cavity of the spar cap mould with a vacuum bag and infuse the resin by vacuum assisted resin transfer moulding (VARTM).

29. Method of claim 16, comprising carrying out an inspection of the cured stack of precured elements and interlayer(s) after the cured stack has been removed from the spar cap mould, conduct any required repairs of the cured stack and send the stack to shell part mould or a storage.

30. System for manufacturing a spar cap for a wind turbine blade part, the system being provided a plurality of precured elongate elements of a fibre reinforced resin composite material comprising a first main surface and a second opposite main surface and a first lateral face and a second opposite lateral face and a first end and an opposite second end, and wherein the plurality of precured elements are stacked with an interlayer of an elongate non-cured fibre material being arranged between the first and second main surface of successive precured elements, thereby forming a stack of precured elements and interlayer(s), the stack having a lower stack surface and an opposite upper stack surface, a first lateral stack face and an opposite second lateral stack face, and a first stack end and an opposite second stack end, the system comprising:
a spar cap mould comprising a mould bottom and mould side walls, and
a lifting device such as a lifting beam adapted to move the stack of precured elements and interlayer(s),
wherein the system is adapted to:
move the stack of precured elements and interlayer(s), with the lifting device, to the spar cap mould comprising a mould bottom and mould side walls,
arrange the stack of precured elements and interlayer(s) in the cavity of the spar cap mould,
infuse resin into the stack of precured elements and interlayers in the mould,
allow the resin to cure to form a cured stack of precured elements and interlayer(s) forming a spar cap,
remove the cured stack of precured elements and interlayer(s) in from the mould, i.e. demould the stack.
